(19) United States
(12) Patent Application Publication
(10) Pub. No.: US 2004/0053034 A1
(43) Pub. Date: Mar. 18, 2004

(54) Method for shielding at least the upper part of a radiocommunication module, and corresponding radiocommunication module

(76) Inventors: Bachir Kordjani, Montigny Le Bretonneux (FR); Jacky Jouan, Sevres (FR)

Correspondence Address: Westman Champlin & Kelly, International Centre Suite 1600, 900 Second Avenue South, Minneapolis, MN, 55402-3319, US

(21) Appl. No.: 10/257,895

(22) PCT Filed: Apr. 19, 2001
(86) PCT No.: PCT/FR01/01215

(30) Foreign Application Priority Data
Apr. 21, 2001 (FR) FR01/01215

(51) Int. Cl. B32B 5/24; D21H 11/00; D21H 13/00

(52) U.S. Cl. 428/311.11

(57) ABSTRACT

The invention concerns a method for shielding at least the upper part of a radiocommunication module (1), said module being designed to be transferred on a mother board (5) and including components mounted on a printed circuit and providing at least one of the following functions. RF processing, digital processing and analog processing. The inventive method is characterised in that it comprises the following steps: coating at least the upper part (2) of said radiocommunication module with a resin and adding an electrically conductive layer at the surface of the resin. The invention also concerns a radiocommunication module whereof at least the upper part is thus shielded.

The field of the invention is that of radiocommunication systems with mobiles.

The invention is applied particularly, but not exclusively, in GSM 900 (Global System for Mobile—900 MHz), DCS 1800 (Digital Cellular System—1800 MHz), PCS 1900 (Personal Communication System—1900 MHz) or UMTS (Universal Mobile Telecommunication System—2 GHz) radiocommunication systems.

More exactly, the invention relates to a method for shielding at least the upper part of a radiocommunication module intended to be mounted in radiocommunication equipment (mobile telephone, and more generally any apparatus or device employing radiocommunications).

Let us, to begin with, remind ourselves of what is meant by a radiocommunication module.

Conventionally, a person subscribing to a radiocommunication system, of the GSM type for example, has at his disposal a mobile station (sometimes also called a mobile telephone or portable telephone) including mobile equipment (ME) generally engaging with a Subscriber Identity Module or SIM card.

In its first application, which is the most conventional, the radiocommunication module (for example a GSM module) is included in the mobile equipment and provides the wireless communication function, controlling various hardware components (screens, keyboard, loudspeaker, etc.) of the mobile equipment.

Other applications of the radiocommunication module are also known.

It has in particular been suggested that it should be integrated in devices other than mobile equipment, which nonetheless require a wireless communication functionality. By way of example, we may cite telemetry devices (meter reading) or again bank card reader devices.

It has also been suggested that the radiocommunication module should be provided independently, with in particular its own power supply: it is then called a modem. A modem of this kind, which includes no man/machine interface hardware elements (screen, keyboard, loudspeaker, etc.), is intended to engage with a third piece of equipment (typically a micro-computer), which does possess man/machine interface hardware elements.

Whatever form the radiocommunication module application takes (in mobile equipment, in some other device, or again in a modem), it conventionally includes a printed circuit, onto which are welded components, a shielding structure and a mechanical connector allowing the module to be interconnected with other elements, such as a mother board.

The components welded onto the printed circuit may in particular provide digital processing, analog processing, and/or radiofrequency processing functions.

The shielding structure allows the radiocommunication module to be shielded electromagnetically (EMT shielding). It conventionally consists of two belts, arranged on each of the faces of the printed circuit respectively, and of two covers which may each be snapped onto one of the two belts, on each of the faces of the module. In other words, the shielding of each of the upper and lower parts of the module conventionally requires a belt and a cover, snapped one onto the other. However, other shielding structures may be used to fulfil the function. One possibility may be to use parallelepiped covers directly welded onto the board, allowing each of the electromagnetically sensitive functions to be separated.

The conventional belt plus cover structure has several drawbacks which run counter to the current concerns of manufacturers.

First of all, it is fairly thick relatively, which prevents any reduction in the space requirement of the radiocommunication module.

This conventional structure is expensive and it is not easy to assemble, given that it consists of an assembly of four distinct parts.

Moreover, it does not generally offer a good level of tightness, particularly to air or dust.

Lastly, it does not allow the implementation and the choices of the components on the printed circuit to be kept secret, since the upper cover has only to be removed to gain direct access to these components.

The particular objective of the present invention is to overcome these different drawbacks of the prior art.

More exactly, one of the objectives of the present invention is to provide a method of shielding at least the upper part of a radiocommunication module, this method allowing the space requirement of the module to be reduced.

Another objective of the invention is to provide a method of this kind which allows the cost of shielding to be much reduced.

Another objective of the invention is to provide a method of this kind, allowing, apart from the shielding function, the tightness and confidentiality of the module to be ensured.

Yet another objective of the invention is to provide a method of this kind making it possible to obtain a module having the same appearance as a conventional casing component.

These different objectives, as well as others which will emerge subsequently, are reached according to the invention by using a method of shielding at least the upper part of a radiocommunication module, said module being intended to be transferred to a mother board and including components mounted on a printed circuit and providing at least one of the following functions: RF processing, digital processing and analog processing. According to the invention, said method includes the following steps: coating at least the upper part of said radiocommunication module with a resin, and adding an electrically conductive layer to the surface of said resin.

The general principle of the invention therefore consists in replacing, at least in the upper part of the module, the belt and the associated cover by a resin coated with an electrically conductive layer (for example a metallized film).

Given the absence of belt and cover, the cost and the space requirement of the module may be reduced. Furthermore, the resin coating confers a good seal on the module, and helps to preserve the confidentiality of the implementation and of the choices of components on the printed circuit.

It is important to note that if using this shielding technique was known in respect of a silicon chip, it was not in any way self-evident for the man skilled in the art to use it for a complete radiocommunication module. Indeed, his prejudices have always led him to believe that the presence within a module of a plurality of components, providing different functions and in particular an RF function, made coating the module in a resin impossible. In other words, he was convinced that what is possible for a single component, namely a chip, is impossible for a plurality of components with a great diversity of technologies (casings, bare chips, radio subassemblies, passive components, quartz, etc.).

To advantage, said radiocommunication module is included in a device belonging to the group including: mobile equipment, devices, other than mobile equipment, requiring a wireless communication functionality, modems, etc.

To advantage, said resin is of the type which can bear remelting, such that the resin coating may be applied before the module is transferred, by remelting, onto the mother board.

Preferentially, said resin is of the type modifying in a predetermined and limited way the permeability and permittivity of the medium surrounding the RF parts of the module. It will be remembered that the module radio function heavily depends on the electromagnetic interaction of the components between themselves. These interactions are known when these components are separated by air, with individually equal permittivity (ε_{Γ}) and relative permeability (μ_{Γ}) In fact, according to the present invention, the components of the coated module bathe in a medium, resin, the characteristics of which in respect of the propagation of electromagnetic waves are different from those of air (particularly ε_{Γ}>1). The printed circuit design, as well as the positions and connections of the components between themselves, must take these interactions into account.

Parasitic coupling phenomena, particularly of the capacitive type, are significant. The capacitance (C) is proportionate to the medium (ε_{Γ}) and inversely proportionate to the distance (d). It therefore increases if the distance between two pins is smaller. The capacitances increase the RF mismatch as well as the frequency limitations (RC).

Preferentially, said resin is a casting resin. Casting resins have the advantage of being easy to employ, when assembling the module. On the other hand, transfer resins require heating to a high temperature and injection under pressure which might damage the components and the module.

Preferentially, said resin is a resin of the epoxy family. It will be remembered that epoxy resins are synthetic polymer materials widely used as plastic structure in electronic components. They are characterised by their low degree of necking-in during polymerisation, their good adhesion, and their good mechanical and chemical resistance.

In a particular embodiment of the invention, said resin is loaded. The load may be silica. The choice of total load must be made with care. Indeed, the more the resin is loaded with silica, the more its relative permittivity increases, which takes it away from the characteristics of air. On the other hand, the less it is loaded with silica, the less satisfactory the mechanical characteristics of the polymerised resin, on account of a reduction in hardness.

According to one advantageous alternative, said resin is loaded with air microbubbles. In this way, we get closer once again to the characteristics of air.

To advantage, at least one injection syringe and at least one mould is used during said step of coating the radiocommunication module with resin.

In this way, the volume of resin to be polymerised is delimited and a good surface condition is obtained. It is to be noted that hot melt technology does not generally use a mould, but possibly a silicone flange when it is necessary to delimit the surface to be coated.

Preferentially, said step of adding a conductive layer consists in depositing a graphite carbon film on the resin surface. The graphite carbon allows the surface hardness to be increased. Furthermore, it allows the module to be given directly an external black colour, with no additional painting operation.

It is clear however that other materials (gold, silver, nickel, etc.) may be chosen without departing from the framework of the present invention. They are chosen as a function of their intrinsic good conductivity (in other words low electrical resistivity) characteristics.

Preferentially, said step of adding a conductive layer is carried out by a vacuum deposition technique. It is clear however that the present invention is not restricted to this particular plating technique.

In a preferential embodiment of the invention, said module includes a set of conductive elements, distributed over the lower surface of said printed circuit, and manufactured in such a way that said set of conductive elements constitutes at one and the same time:

means of electromagnetically shielding the lower face of said printed circuit;

electrical interconnection means, passing electrical signals to and/or from said mother board; and

means of transferring said radiocommunication module onto said mother board;

in such a way that said radiocommunication module forms an electronic macro-component.

In other words, the present invention is compatible with a totally new and inventive approach to designing the radiocommunication module in the form of a macro-component.

The invention also relates to a radiocommunication module, of the type intended to be transferred to a mother board and including components mounted on a printed circuit and providing at least one of the following functions: RF processing, digital processing and analog processing. According to the invention, at least the upper part of said radiocommunication module is coated with a resin the surface of which is covered by a conductive layer.

Other characteristics and advantages of the invention will emerge from reading the following description of a preferential embodiment of the invention, given purely by way of example and non-restrictively, and the appended drawings, wherein:

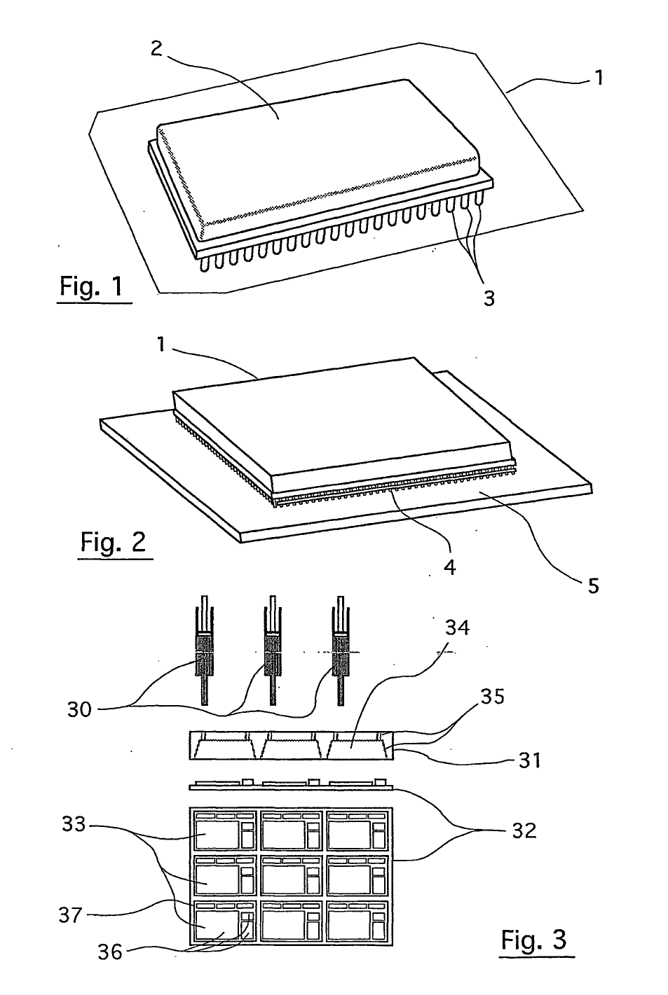

FIG. 1 shows a perspective view of a particular embodiment of a radiocommunication module according to the present invention;

FIG. 2 shows the module in FIG. 1, following transfer onto a mother board; and

FIG. 3 shows an embodiment of the step of coating the module with a resin.

The invention therefore relates to a method of shielding at least the upper part of a radiocommunication module. According to the present invention, the radiocommunication module 1 (i.e. particularly the printed circuit and the different components welded onto it) is coated with a resin, the surface of which is covered with an electrically conductive layer (for example a metallized film).

In the example shown, the shielding relates solely to the upper part 2 of the module 1. The conductive layer or structure (for example plating) on the resin surface provides the electromagnetic shielding of the (upper) coated face of the module in respect of the outside. A Faraday cage needs to be made around this face, connecting this conductive surface to an earth plane covering the surface of the printed circuit.

In the example shown in FIGS. 1 and 2, the module 1 is in the form of a macro-component. To this end, it includes an assembly of conductive elements 3 performing the three following functionalities: electromagnetic shielding of the lower part of the module, electrical interconnection and transfer to a mother board. For more details on this embodiment of the module in the form of a macro-component, reference may be made to French patent application no. 99 001264, filed on the Jan. 31, 2000, and the text and drawings of which are inserted here for reference purposes.

In the example shown in FIG. 2, the module 1 is transferred to a mother board 5 using a column interposition structure 4. The resin is chosen in such a way that this transfer can be carried out by remelting, with SMC (Surface Mounted Component) welds.

In a general way, the resin selection criteria are for example as follows:

high fluidity (very low viscosity, <5000 cps at 25° C.);

lowest polymerisation temperature and time (T<150° C.);

low degree of necking-in at polymerisation (<0.7%);

and once polymerised:

closest unit permittivity and permeability;

low coefficient of efflux (tgδ<5×10⁻² at 1 GHz);

high degree of hardness (Shore hardness D>70);

high impermeability (water absorption<0.25%);

low coefficient of expansion (α<10⁻⁶ M/° C.);

good thermal conductivity;

low ionic conductivity;

good power of adhesion;

low density;

black colour;

plating potential;

etc.

The resin is for example a casting resin of the epoxy family, correctly loaded. In the case of a silica load, the resin is for example that bearing the reference number FP4450 from the supplier DEXER HYSOL. In the case of an air microbubble load, the resin is that bearing the reference number MNB 124-28 from the same supplier.

As shown in the view from the side in FIG. 3, the step of coating the module with a casting resin may be carried out with injection syringes 30, which contain the freshly prepared resin, and a mould 31, having a form complementary to that of a mat of modules 32. For each module in the mat 32, the mould has therefore a cavity 34 to be filled with resin, as well as vents 35 for the flow.

The lower part of FIG. 3 has a view from above of an example of a mat 32 of nine modules 33. It will be remembered that the module mat is the format used for assembling components 36 on the printed circuit 37 as SMC.

The material used for surface plating is for example graphite carbon (C). The thickness of the carbon layer is chosen so as to provide sufficient radio attenuation.

In a general way, the criteria for selecting this material are for example as follows:

low electrical resistivity (i.e. high electrical conductivity);

black colour.

This plating is for example carried out by vacuum deposition of carbon, by heating a graphite filament with a very strong current, so as to spray atoms on the resin coating surface.

It is clear that a number of other embodiments of the invention are conceivable.

In particular it is possible to use other types of resin and/or other plating materials (gold, silver, nickel, etc.).

Other techniques of coating the module with resin and/or other techniques of depositing a metallized film on the surface of the resin coating (metallized paint, etc.) may also be used.

1. A method of shielding at least the upper part of a radiocommunication module (1; 33), said module being intended to be transferred to a mother board (5) and including components mounted on a printed circuit and providing at least one of the following functions: RF processing, digital processing and analog processing,
characterised in that it includes the following steps:
coating at least the upper part (2) of said radiocommunication module with a resin;
adding an electrically conductive layer to the surface of said resin.

2. A method according to claim 1, characterised in that said radiocommunication module (1; 33) is included in a device belonging to the group including:
mobile equipment;
devices, other than mobile equipment, requiring a wireless communication functionality;
modems.

3. A method according to any one of claims 1 and 2, characterised in that said resin is of the type which can bear remelting, such that the resin coating may be applied before the module (1; 33) is transferred, by remelting, to the mother board (5).

4. A method according to any one of claims 1 to 3, characterised in that said resin is of the type modifying in a predetermined and limited way the permeability and permittivity of the medium surrounding the RF parts of the module.

5. A method according to any one of claims 1 to 4, characterised in that said resin is a casting resin.

6. A method according to any one of claims 1 to 5, characterised in that said resin is a resin of the epoxy family.

7. A method according to any one of claims 1 to 6, characterised in that said resin is loaded.

8. A method according to claim 7, characterised in that said resin is loaded with air microbubbles.

9. A method according to any one of claims 1 to 8, characterised in that at least one injection syringe (30) and at least one mould (31) is used during said step of coating the radiocommunication module (1; 33) with resin.

10. A method according to any one of claims 1 to 9, characterised in that said step of adding a conductive layer consists in depositing a graphite carbon film on the resin surface.

11. A method according to any one of claims 1 to 10, characterised in that said step of adding a conductive layer is carried out by a vacuum deposition technique.

12. A method according to any one of claims 1 to 11, characterised in that said module includes a set of conductive elements (4), distributed over the lower face of said printed circuit, and manufactured in such a way that said set of conductive elements constitutes at one and the same time:
means of electromagnetically shielding the lower face of said printed circuit;
electrical interconnection means, passing electrical signals to and/or from said mother board; and
means of transferring said radiocommunication module onto said mother board; in such a way that said radiocommunication module (1; 33) forms an electronic macro-component.

13. A radiocommunication module (1; 33), of the type intended to be transferred to a mother board (5) and including components (36) mounted on a printed circuit (37) and providing at least one of the following functions: RF processing, digital processing and analog processing,
characterised in that at least the upper part (2) of said radiocommunication module is coated with a resin the surface of which is covered by a conductive layer.
